(19) United States
(12) Patent Application Publication
(10) Pub. No.: US 2023/0415835 A1
(43) Pub. Date: Dec. 28, 2023

(54) MOTORCYCLE KICKSTAND MOUNTING METHOD AND SYSTEM

(71) Applicant: Connor Kindom, Hudson, WI (US)

(72) Inventor: Connor Kindom, Hudson, WI (US)

(21) Appl. No.: 17/846,120

(22) Filed: Jun. 22, 2022

(51) Int. Cl. B62H 1/02; B62J 11/00; B62J 50/26

(52) U.S. Cl. CPC B62H 1/02; B62J 11/00; B62J 50/26

(57) ABSTRACT

A motorcycle kickstand mounting assembly includes a mount for holding a license plate of a motorcycle. A kickstand plate supports a kickstand of the motorcycle on a ground surface to prevent the kickstand from sinking into the ground surface. The kickstand plate is comprised of a material allowing the license plate to be seen through the kickstand plate when the kickstand plate covers the license plate. A plurality of couplers releasably couples the kickstand plate in a stored position covering the license plate such that the license plate is positioned between the kickstand plate and the mount.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention

The disclosure relates to kickstand support storage device and more particularly pertains to a new kickstand support storage device for mounting and storing a kickstand plate in a convenient and secure location such that it is easily retrievable when needed while simultaneously utilizing a small amount of space. Kickstand plates are utilized by a motorcyclist when there may be a concern that the kickstand will sink into a ground surface. This may happen because the ground surface comprises wet, soft, or loose soil, or because the surface may comprise a material such as asphalt which softens when sufficiently heated by the sun and ambient temperatures. The kickstand plate spreads out the area of force being exerted onto the ground surface by the kickstand and thereby prevents the motorcycle from falling over as can happen when the kickstand sinks into the ground surface. However, retaining a kickstand plate on a motorcycle for usage as needed can be cumbersome where storage space on a motorcycle is extremely limited.

### (2) Description of Related Art Including Information Disclosed Under 37 CFR 1.97 and 1.98

The prior art relates to kickstand support storage devices that allow a motorcyclist to store a kickstand plate in various locations on the motorcycle or behind a license plate.

While sufficient in their intended purpose, these are devices are cumbersome to access or mount, and is often located in undesirable locations.

### BRIEF SUMMARY OF THE INVENTION

An embodiment of the disclosure meets the needs presented above by generally comprising a mount configured for holding a license plate of a motorcycle. A kickstand plate is configured to support a kickstand of the motorcycle on a ground surface to prevent the kickstand from sinking into the ground surface. The kickstand plate is comprised of a material allowing the license plate to be seen through the kickstand plate when the kickstand plate covers the license plate. A plurality of couplers releasably couples the kickstand plate in a stored position covering the license plate such that the license plate is positioned between the kickstand plate and the mount.

In another embodiment, the disclosure teaches a system including a motorcycle having a kickstand and a license plate. A mount releasably mounts the license plate to the motorcycle. A kickstand plate is supporting the kickstand of the motorcycle on a ground surface to prevent the kickstand from sinking into the ground surface. The kickstand plate is comprised of a material allowing the license plate to be seen through the kickstand plate when the kickstand plate covers the license plate. A plurality of couplers releasably couples the kickstand plate in a stored position covering the license plate such that the license plate is positioned between the kickstand plate and the mount.

In yet another embodiment, the disclosure teaches a method including the steps of positioning a kickstand plate over a license plate such that the kickstand plate covers the indicia on a license plate. The kickstand plate comprises a substantially transparent material such that the indicia is visible through the kickstand plate. The kickstand plate is releasably couples in a stored position covering the license plate with a plurality of couplers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING

The disclosure will be better understood and objects other than those set forth above will become apparent when consideration is given to the following detailed description thereof. Such description makes reference to the annexed drawings wherein:

FIG. 1 is a front isometric view of a kickstand plate of a motorcycle kickstand mounting method and system according to an embodiment of the disclosure.

FIG. 2 is a rear isometric view of the kickstand plate of an embodiment of the disclosure.

FIG. 3 is a cross-sectional view of an embodiment of the disclosure taken along line 3-3 of FIG. 1.

FIG. 4 is a front, exploded isometric view of an embodiment of the disclosure.

FIG. 5 is a top isometric view of an embodiment of the disclosure.

FIG. 6 is a front isometric view of an embodiment of the disclosure.

FIG. 7 is a side view of an embodiment of the disclosure.

FIG. 8 is a rear in-use view of an embodiment of the disclosure.

FIG. 9 is a side isometric in-use view of an embodiment of the disclosure.

### DETAILED DESCRIPTION OF THE INVENTION

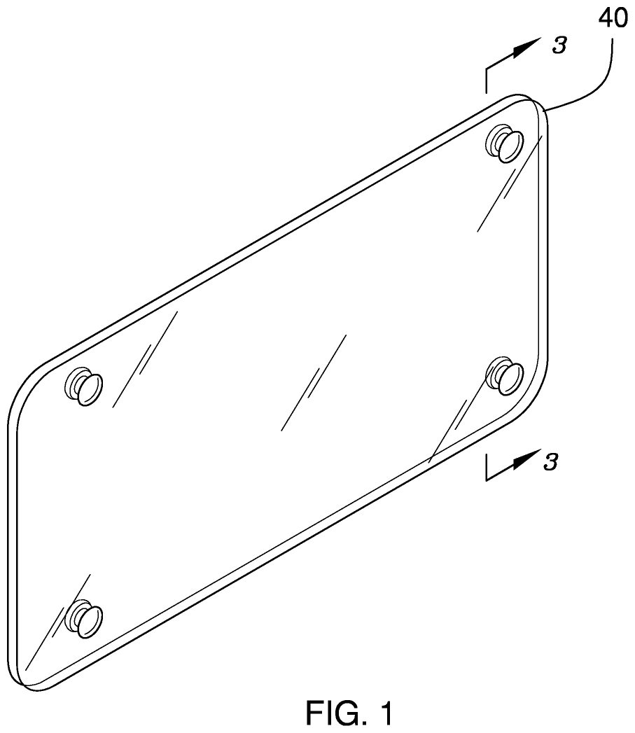

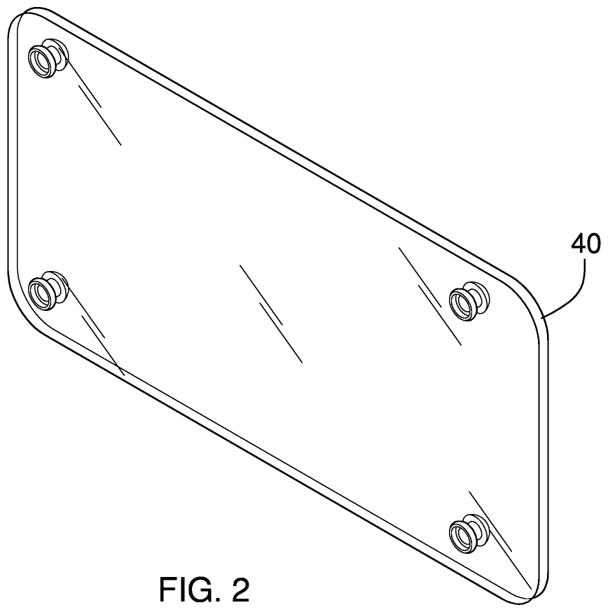

With reference now to the drawings, and in particular to FIGS. 1 through 9 thereof, a new kickstand support storage device embodying the principles and concepts of an embodiment of the disclosure and generally designated by the reference numeral 10 will be described.

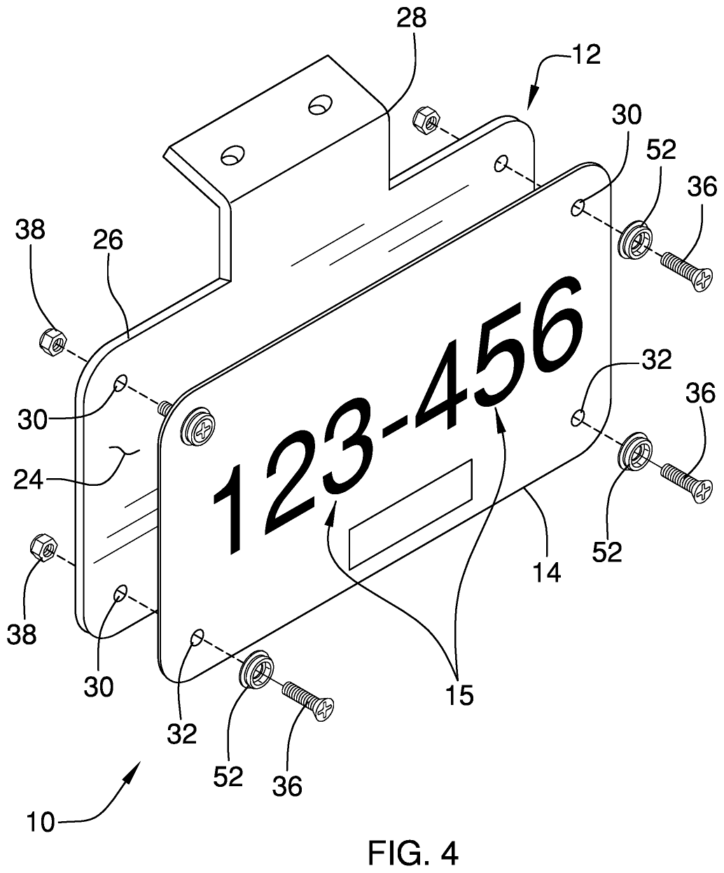

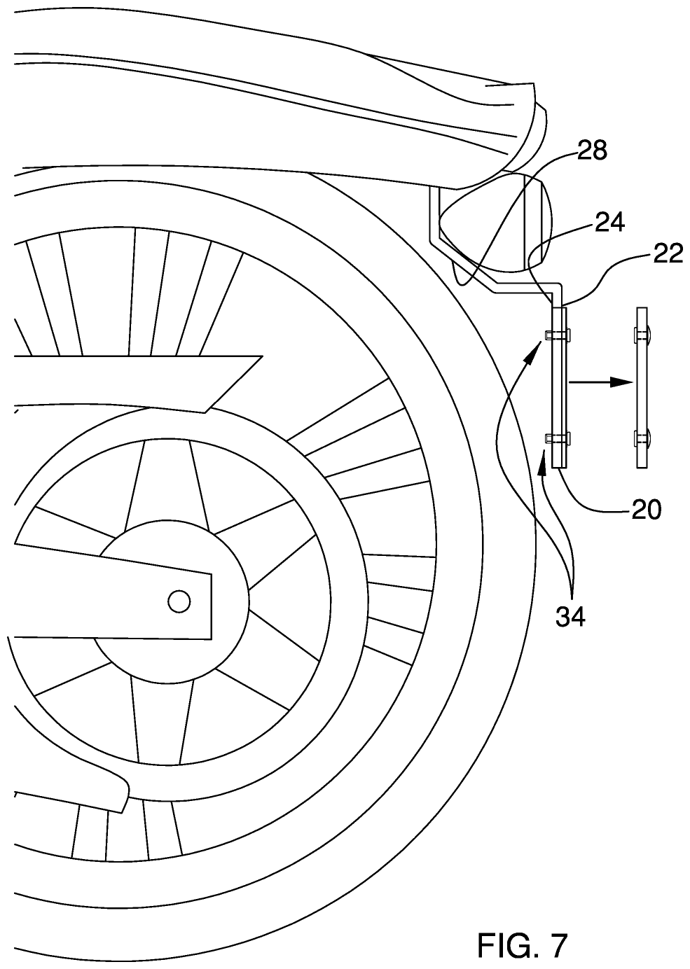

As best illustrated in FIGS. 1 through 9, the motorcycle kickstand mounting method and system 10 generally comprises a mount 12 configured for holding a license plate 14 for a motorcycle 16. The mount 12 includes a panel 20 having a front side 22, a rear side 24, and a perimeter edge 26. A bracket 28 is attached to the panel 20 and is configured to be releasably secured to the motorcycle 16 such that the front side 22 is in a horizontal orientation. As can be seen in FIGS. 4 and 7, the bracket 28 may have different structural configurations and the structural configuration is most often determined by the structure of the motorcycle 12. Thus, the bracket 28 may have a structure for attaching below a seat, to a fender, or to the frame of the motorcycle 16 either above or lateral to the rear wheel of the motorcycle 16. The panel 20 and the bracket 28 are comprised of typical materials, usually metals, but may include plastics, graphite composites, and the like.

The panel 20 has a plurality of mounting apertures 30 extending therethrough. Each of the mounting apertures 30 is alignable with one of a plurality of mounting holes 32 extending through the license plate 14. The mount 12 further includes a plurality of fasteners 34. Each of the fasteners 34 extends through an aligned one of the mounting apertures 30 and mounting holes 32 to releasably secure the license plate 14 to the panel In one embedment, as shown in FIG. 4, the fastener 34 may include a threaded screw 36 and nut 38 combination though in some instances the fastener 34 may only include the threaded screw 36 wherein the mounting apertures 30 are threaded.

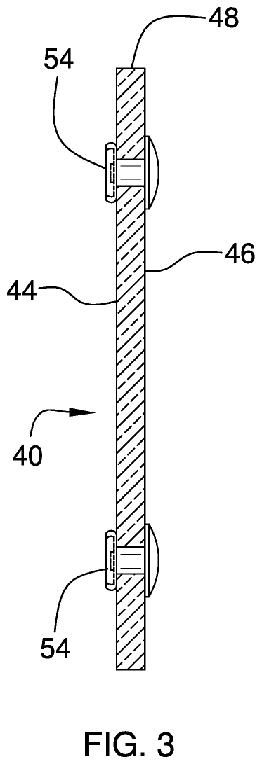

A kickstand plate 40 is configured to support a kickstand 18 of the motorcycle 16 on a ground surface 42 to prevent the kickstand 40 from sinking into the ground surface 42. The kickstand plate 40 is comprised of a material allowing the license plate 14 to be seen through the kickstand plate 40 when the kickstand plate 40 covers the license plate 16. Thus, the kickstand plate 40 is substantially transparent. The term “substantially transparent” is intended to mean that indicia 15 positioned on the license plate 14 is visible through the kickstand plate 40. This allows for the kickstand plate 40 to be tinted for aesthetic purposes. Though the kickstand plate 40 may have first 44 and second 46 sides each being planar as shown in FIG. 3, the kickstand plate 40 second side 46 may have a slightly curved shape, particularly adjacent to its peripheral edge 48.

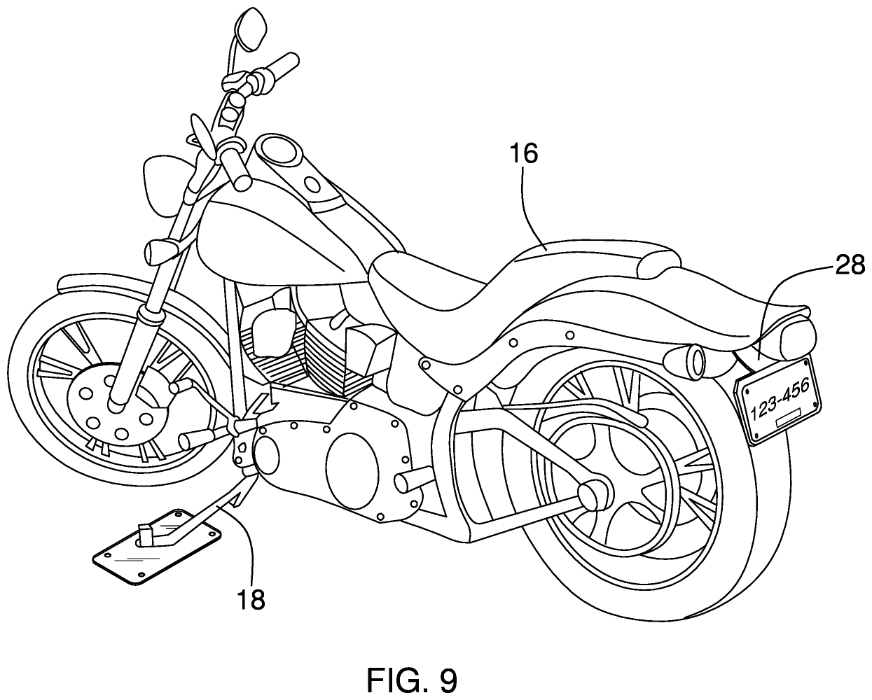

The kickstand plate 40 may be comprised of conventional materials that are transparent, but which are strong enough to support the motorcycle 16 as shown in FIG. 9. These materials, in particular, may include strong, impact resistant plastics such as acrylic plastic, polymethyl methacrylate, polycarbonates, cellulose acetate butyrate, ethylene tetrafluoroethylene, and the like.

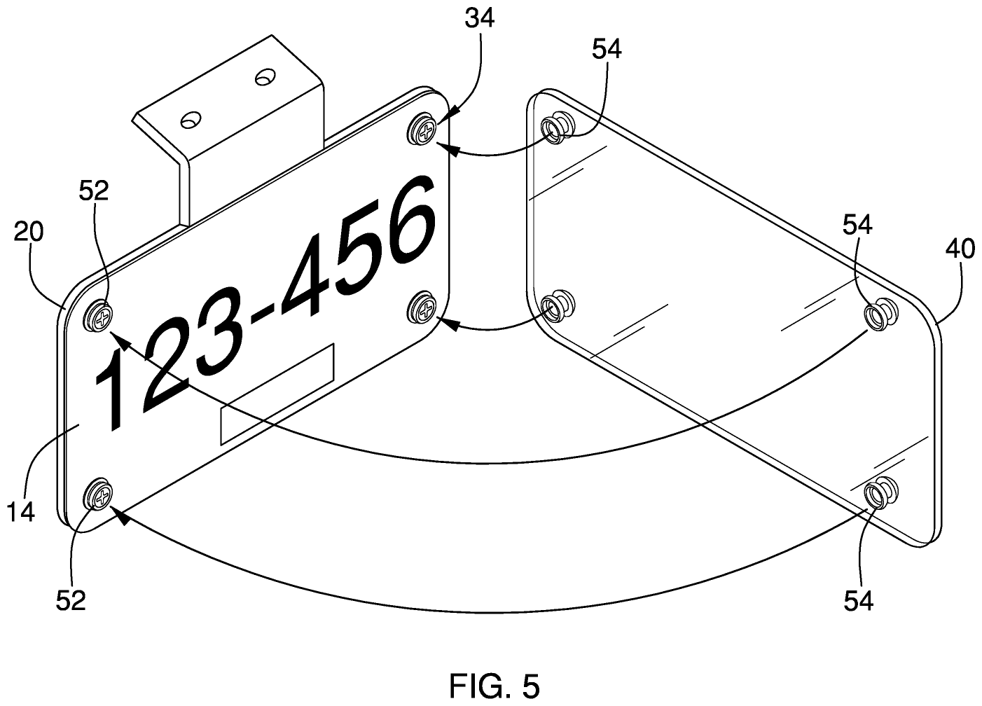

A plurality of couplers 50 releasably couple the kickstand plate 40 in a stored position covering the license plate 14 such that the license plate 14 is positioned between the kickstand plate 40 and the mount 12. Typically, each of the couplers 50 includes a first mating member 52 and a second mating member 54, wherein each of the fasteners 34 includes the first mating member 54. More particularly, the first mating member 52 may be structurally integral or removably attached to a head of the threaded screw 36 and each of the second mating members 54 is attached to the kickstand plate 40. In one embodiment, each of the couplers 50 comprises a snap button as shown in FIG. 5. It should be understood that the couplers 50 may instead comprise hook and loop couplers, magnets, clips and the like. In an embodiment, not shown, the kickstand plate 40 may include magnets which are magnetically coupled to the license plate 14 or, more preferably, the panel 20 of the mount 12.

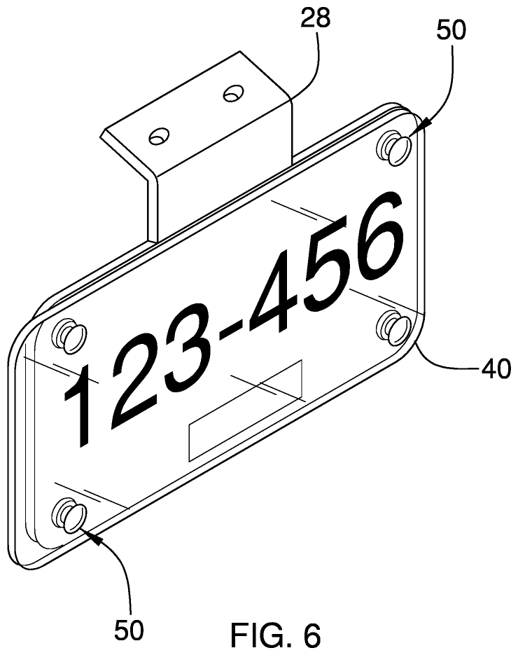

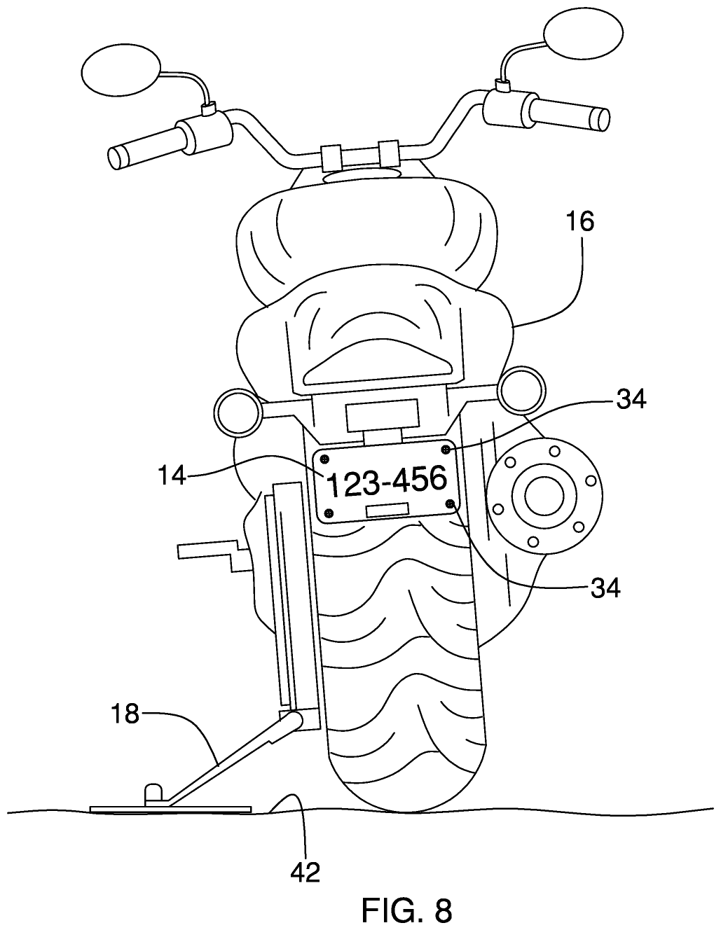

In use, the mount 12 is attached to the motorcycle 16 in a manner conventional to motorcycle license plate mounts. The license plate 14 is then attached to the mount 12. The kickstand plate 40 can thereafter be attached to the mount 12 such that that license plate 14 is covered by the kickstand plate 40 as shown in FIGS. 6 and 7. When needed, the kickstand plate 40 is removed as best depicted in FIGS. 8 and 9 and used to prevent the kickstand 18 from sinking into the ground surface 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle kickstand plate and mounting assembly configured to releasably mount a kickstand plate over a license plate of a motorcycle, the assembly including:
a mount configured for holding the license plate;
a kickstand plate being configured to support a kickstand of the motorcycle on a ground surface to prevent the kickstand from sinking into the ground surface, the kickstand plate being comprised of a material allowing the license plate to be seen through the kickstand plate when the kickstand plate covers the license plate; and
a plurality of couplers releasably coupling the kickstand plate in a stored position covering the license plate such that the license plate is positioned between the kickstand plate and the mount.

2. The motorcycle kickstand plate and mounting assembly according to claim 1, wherein the mount includes a panel having a front side, a rear side, and a perimeter edge, a bracket being attached to the panel, the bracket being configured to be releasably secured to the motorcycle such that the front side is in a horizontal orientation.

3. The motorcycle kickstand plate and mounting assembly according to claim 2, wherein:
the panel has a plurality of mounting apertures extending therethrough, each of the mounting apertures being alignable with one of a plurality of mounting holes extending through the license plate; and
a plurality of fasteners, each of the fasteners extending through an aligned one of the mounting apertures and mounting holes to releasably secure the license plate to the panel.

4. The motorcycle kickstand plate and mounting assembly according to claim 1, wherein each of the couplers including a first mating member and a second mating member, each of the first mating members being secured to the mount, each of the second mating members being attached to the kickstand plate. The motorcycle kickstand plate and mounting assembly according to claim 3, wherein each of the fasteners includes the first mating member, each of the second mating members being attached to the kickstand plate.

6. The motorcycle kickstand plate and mounting assembly according to claim wherein each of the couplers comprises a snap button.

7. A motorcycle kickstand plate and mounting system including:
a motorcycle including a kickstand and a license plate;
a mount releasably mounting the license plate to the motorcycle;
a kickstand plate being supporting the kickstand of the motorcycle on a ground surface to prevent the kickstand from sinking into the ground surface, the kickstand plate being comprised of a material allowing the license plate to be seen through the kickstand plate when the kickstand plate covers the license plate; and
a plurality of couplers releasably coupling the kickstand plate in a stored position covering the license plate such that the license plate is positioned between the kickstand plate and the mount.

8. The motorcycle kickstand plate and mounting system according to claim 7, wherein the mount includes a panel having a front side, a rear side, and a perimeter edge, a bracket being attached to the panel, the bracket being releasably secured to the motorcycle such that the front side is in a horizontal orientation.

9. The motorcycle kickstand plate and mounting system according to claim 8, wherein:
the panel has a plurality of mounting apertures extending therethrough, each of the mounting apertures being alignable with one of a plurality of mounting holes extending through the license plate; and
a plurality of fasteners, each of the fasteners extending through an aligned one of the mounting apertures and mounting holes to releasably secure the license plate to the panel.

10. The motorcycle kickstand plate and mounting system according to claim 7, wherein each of the couplers including a first mating member and a second mating member, each of the first mating members being secured to the mount, each of the second mating members being attached to the kickstand plate.

11. The motorcycle kickstand plate and mounting assembly according to claim 9, wherein each of the fasteners includes the first mating member, each of the second mating members being attached to the kickstand plate.

12. The motorcycle kickstand plate and mounting assembly according to claim 11, wherein each of the couplers comprises a snap button.

13. A method of storing a motorcycle kickstand plate comprising the steps of:
positioning a kickstand plate over a license plate such that the kickstand plate covers indicia on the license plate, the kickstand plate comprising a substantially transparent material such that the indicia is visible through the kickstand plate; and
releasably coupling the kickstand plate in a stored position covering the license plate with a plurality of couplers.

14. The method of claim 13, wherein the step of releasably coupling the kickstand plate in the store position further includes snappily coupling first mating members positioned on fasteners extending through the license plate to second mating members positioned on the kickstand plate.
